(19) United States
(12) Patent Application Publication
(10) Pub. No.: US 2026/0371235 A1
(43) Pub. Date: Nov. 19, 2026

(54) SYSTEM AND METHOD FOR NF SELECTION FOR ACCESS AND MOBILITY MANAGEMENT IN A SERVICE-BASED ARCHITECTURE

(71) Applicant: Samsung Electronics Co., Ltd., Suwon-si, Gyeonggi-do (KR)

(72) Inventors: Avneesh TIWARI, Bengaluru (IN); Manasi EKKUNDI, Bengaluru (IN); Neha SHARMA, Bengaluru (IN); Dongmyoung KIM, Suwon-si (KR)

(21) Appl. No.: 19/488,460

(22) PCT Filed: May 16, 2024
(86) PCT No.: PCT/KR2024/006672

§ 371 Date: Nov. 26, 2025

(30) Foreign Application Priority Data
May 30, 2023 (IN) 202341037203
Mar. 22, 2024 (IN) 202341037203

(51) Int. Cl. H04W 48/18; H04W 48/16; H04W 76/10

(52) U.S. Cl. CPC H04W 48/18; H04W 48/16; H04W 76/10

(57) ABSTRACT

The disclosure relates to a 5G or 6G communication system for supporting a higher data transmission rate. Present disclosure describes multiple embodiments relating to network function (NF) selection for access and mobility management in a service-based architecture. In an embodiment, a central unit (CU)-control plane (CP) NF directly communicates with a target Access and Mobility Function (AMF) using locally configured parameters. In an embodiment, an AMF selection is done via a Network Repository Function (NRF) by the CU-CP. In an embodiment, the CU-CP NF does discovery of an AMF by querying the NRF, and sends the request to SCP containing the address of a selected AMF. In an embodiment, the CU-CP NF adds any necessary discovery and selection parameters required to find a suitable AMF to a request message for the SCP.

### TECHNICAL FIELD

The present disclosure relates to Network Function (NF) selection for access and mobility management in an end-to-end service-based architecture (Radio Access Network (RAN) modules and Core Network (CN) modules, both are connected through Service Based Interfaces (SBIs)).

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mecahnisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

The information disclosed in this background of the disclosure section is only for enhancement of understanding of the general background of the invention and should not be taken as an acknowledgement or any form of suggestion that this information forms the prior art already known to a person skilled in the art.

### DISCLOSURE OF INVENTION

### Solution to Problem

The present disclosure tries to address the aforesaid problem associated with wireless communication network architecture.

In an embodiment, the present disclosure relates to a method for NF selection for access and mobility management in a service-based architecture. The method comprising configuring, by a Central Unit (CU)-Control Plane (CP) NF, the CU-CP NF locally using an Access and Mobility Management Function (AMF) parameter set to enable selection of an AMF at the CU-CP NF. Subsequently, the method comprises transmitting, by the CU-CP NF, a service request to the (target/selected) AMF, wherein the service request comprises the AMF parameter set. Lastly, the method comprises receiving, by the CU-CP NF, a service response from the AMF to establish a connection with the AMF for services.

In an embodiment, the present disclosure relates to a system for NF selection for access and mobility management in a service-based architecture. The system comprising a CU-CP NF, wherein the CU-CP NF comprises a processor and a memory communicatively coupled to the processor. The CU-CP NF configures the CU-CP NF locally using an AMF parameter set to enable selection of an AMF at the CU-CP NF. Subsequently, the CU-CP NF is configured to transmit a service request to the (target/selected) AMF, wherein the service request comprises the AMF parameter set. Lastly, the CU-CP NF is configured to receive a service response from the AMF to establish a connection with the AMF for services.

In an embodiment, the present disclosure relates to a method for NF selection for access and mobility management in a service-based architecture. The method comprising transmitting, by a CU-CP NF, a NF discovery request to a Network Repository Function (NRF), wherein the NF discovery request comprises an AMF parameter set for an AMF selection. Thereafter, the method comprises selecting, by the NRF, at least one AMF upon receiving the NF discovery request. Subsequently, the method comprises transmitting, by the NRF, a NF discovery response to the CU-CP NF upon completing the selection for the at least one AMF, wherein the NF discovery response comprises of the at least one AMF. Lastly, the method comprises establishing, by the CU-CP NF, a connection with one of the at least one AMF for services.

In an embodiment, the present disclosure relates to a system for NF selection for access and mobility management in a service-based architecture. The system comprising a CU-CP NF and a NRF. The CU-CP NF comprises a first processor and a first memory communicatively coupled to the first processor. The NRF comprises a second processor and a second memory communicatively coupled to the second processor. The CU-CP NF is configured to transmit a NF discovery request to the NRF, wherein the NF discovery request comprises an AMF parameter set for an AMF selection and establish a connection with one of the at least one AMF for services. The NRF is configured to select at least one AMF upon receiving the NF discovery request and transmit a NF discovery response to the CU-CP NF upon completing the selection for the at least one AMF, wherein the NF discovery response comprises of the at least one AMF.

In an embodiment, the present disclosure relates to a method for NF selection for access and mobility management in a service-based architecture. The method comprising transmitting, by a CU-CP NF, a NF discovery request to a Service Communication Proxy (SCP), wherein the NF discovery request comprises an AMF parameter set for an AMF selection. Thereafter, the method comprises selecting, by the SCP, at least one AMF upon receiving the NF discovery request. Subsequently, the method comprises transmitting, by the SCP, a NF discovery response to the CU-CP NF upon completing the selection for the at least one AMF, wherein the NF discovery response comprises of the at least one AMF. Lastly, the method comprises establishing, by the CU-CP NF, a connection with one of the at least one AMF for services.

In an embodiment, the present disclosure relates to a system for NF selection for access and mobility management in a service-based architecture. The system comprising a CU-CP NF and a SCP. The CU-CP NF comprises a first processor and a first memory communicatively coupled to the first processor. The SCP comprises a third processor and a third memory communicatively coupled to the third processor. The CU-CP NF is configured to transmit a NF discovery request to the SCP, wherein the NF discovery request comprises an AMF parameter set for an AMF selection and establish a connection with one of the at least one AMF for services. The SCP is configured to select at least one AMF upon receiving the NF discovery request and transmit a NF discovery response to the CU-CP NF upon completing the selection for the at least one AMF, wherein the NF discovery response comprises of the at least one AMF.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of this disclosure, illustrate exemplary embodiments and together with the description, serve to explain the disclosed principles. In the figures, the left-most digit(s) of a reference number identifies the figure in which the reference number first appears. The same numbers are used throughout the figures to reference like features and components. Some embodiments of system and methods in accordance with embodiments of the present subject matter are now described below, by way of example only, and with reference to the accompanying figures.

FIG. 1 illustrates an environment for NF selection for access and mobility management in a service-based architecture in accordance with an embodiment of the present disclosure.

FIGS. 2a and 2b illustrate an environment for NF selection for access and mobility management in a service-based architecture in accordance with an embodiment of the present disclosure.

FIG. 3 illustrates an environment for NF selection for access and mobility management in a service-based architecture in accordance with an embodiment of the present disclosure.

FIG. 4 illustrate a flowchart showing a method for NF selection for access and mobility management in a service-based architecture in accordance with an embodiment of the present disclosure.

FIG. 5 illustrate a flowchart showing a method for NF selection for access and mobility management in a service-based architecture in accordance with an embodiment of the present disclosure.

FIG. 6 illustrate a flowchart showing a method for NF selection for access and mobility management in a service-based architecture in accordance with an embodiment of the present disclosure.

FIG. 7 illustrates a network entity according to embodiments of the present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### MODE FOR THE INVENTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

A 5G service-based core network architecture (or service-based architecture, SBA) brings more scalability and flexibility as any network function (NF) node (or entity) can interact with any other node in the 5G system architecture. A NF service is one type of capability exposed by an NF (e.g., NF Service Producer) to other authorized NF (e.g., NF Service Consumer) through the service-based interface. Furthermore, a NF in the SBA shall support the mechanisms of the NF service framework: NF service registration and de-registration, NF service authorization, NF service discovery, and/or inter service communication. These NFs can also support communication via existing 3rd Generation Partnership Project (3GPP)-supported formats like: direct communication without network repository function (NRF), direct communication with NRF, indirect communication without delegateddiscovery, and/or indirect communication with delegated discovery. The SBI may use Hypertext Transfer Protocol (HTTP)/2 types or equivalent protocols for establishing connectivity between the Core NFs (e.g., Access and Mobility Function (AMF), Session Management Function (SMF), Unified Data Management (UDM) etc.).

The 5G system architecture shall leverage service-based interactions between CP (control plane) network functions. In this case, a set of NFs provides services to other authorized NFs to access their services through a Service based Interface (SBI). In a wireless communication network architecture such as 5G, a Radio Access Network (RAN) is connected with a Core Network (CN) NF e.g., AMF via a NG/N2 interface. During the next generation (NG) interface setup, the AMF configures the RAN with information required to perform AMF selection at RAN. For example, AMF discovery and selection procedures are defined when RAN module(s) (e.g., central unit (CU) control plane (CP), central unit user plane (UP), or distributed unit (DU)) start(s) supporting the SBA. All the Core Network entities (e.g., NFs), a user equipment (UE) and RAN entity (e.g., CU) are connected with each other via SBI. The RAN performs the AMF selection to determine the AMF-User Equipment (UE) association based on multiple factors like UE's temporary identifier or other information like slicing information, onboarding indication, etc. Although, the 5G network architecture is based on a service-based interface, the RAN to the AMF is still a point-to-point interaction. That is, due to network function virtualization, the RAN as well as the CN entities (other than AMF) may be at same location but still the RAN can only interact with a single CN entity, which is the AMF i.e., becoming the point-to-point interaction. The RAN as well as the AMF becomes an anchor for all UE control messages and each message has to pass through the RAN and the AMF.

Some of the definition of the terms used in the present disclosure are listed below.

NRF: The NRF is a key element of the 5G and 6G CN. The NRF essentially acts as an index that can be consulted by other NFs, so these NFs can discover information regarding other NF entities present in the CN, as well as service capabilities that may be required.

AMF: The AMF is part of the 5G core (5GC) network architecture and is responsible for access management and mobility management functions. The AMF coordinates authentication, registration, and mobility of a UE within the 5G network.

SCP: The service communication proxy (SCP) is a decentralized solution and composed of control plane and data plane. This solution is deployed along side of 5G and 6G NF for providing routing control, resiliency, and observability to the CN.

CU-CP: The functionality of a RAN is sometimes distributed. In that case, the resulting architecture is formed by a CU that controls one or more DUs. A DU is connected to a remote radio head (RRH), i.e., the actual radio transceiver. The CU is again split in two parts i.e., one for control plane functions (CU-CP) and one for user plane functions (CU-UP). In case of fully service based RAN, CU-CP and CU-UP both will act as a NF and will communicate with other NFs using SBIs.

Weight factor: The AMF load balancing functionality permits UEs that are entering into an AMF region or AMF set to be directed to an appropriate AMF in a manner that achieves load balancing between AMFs. This is achieved by setting a weight factor for each AMF, such that the probability of a 5G RAN selecting an AMF is proportional to weight factor of the AMF. The weight factor is typically set according to the capacity of an AMF node relative to other AMF nodes. The weight factor is sent from the AMF to the 5G RAN via NG application protocol (NGAP) messages.

TABLE 1

| Abbreviation | Description |
|---|---|
| UE | User Equipment |
| NF | Network Function |
| CN | Core Network |
| RAN | Radio Access Network |
| SBIs | Service Based Interfaces |
| 5GC | 5G Core |
| CU | Central Unit |
| DU | Distributed Unit |
| RRH | Remote Radio Head |
| CU-CP | Central Unit-Control Plane |
| CU-UP | Central Unit-User Plane |
| AMF | Access and Mobility Management Function |
| NRF | Network Repository Function |
| SCP | Service Communications Proxy |
| 5G | Fifth Generation |
| 6G | Sixth Generation |
| TMSI | Temporary Mobile Subscriber Identity |
| GUAMI | Globally Unique AMF ID |
| NSSAI | Network Slice Selection Assistance Information |
| IAB | Integrated Access and Backhaul |
| NB-IoT | Narrowband Internet of Things |
| RAT | Radio Access Technology |
| CIoT | Cellular IoT |
| RRC | Radio Resource Control |
| SNPN | Standalone Non-Public Network |
| I-O interface | Input-Output interface |
| HSPA+ | High-Speed Packet Access |
| WiMax | Worldwide interoperability for Microwave access |
| RAID | Redundant Array of Independent Dises |
| ASIC | Application Specific Integrated Circuit |
| PGA | Programmable Gate Array |
| RAM | Random Access Memory |
| ROM | Read-Only Memory |
| DRAM | Dynamic RAM |
| SRAM | Static RAM |
| EEPROM | Electrically Erasable PROM |
| PROM | Programmable ROM |
| NG-RAN | Next Generation Radio Access Network |
| NGAP | Next Generation Application Protocol |
| CD | Compact disc |

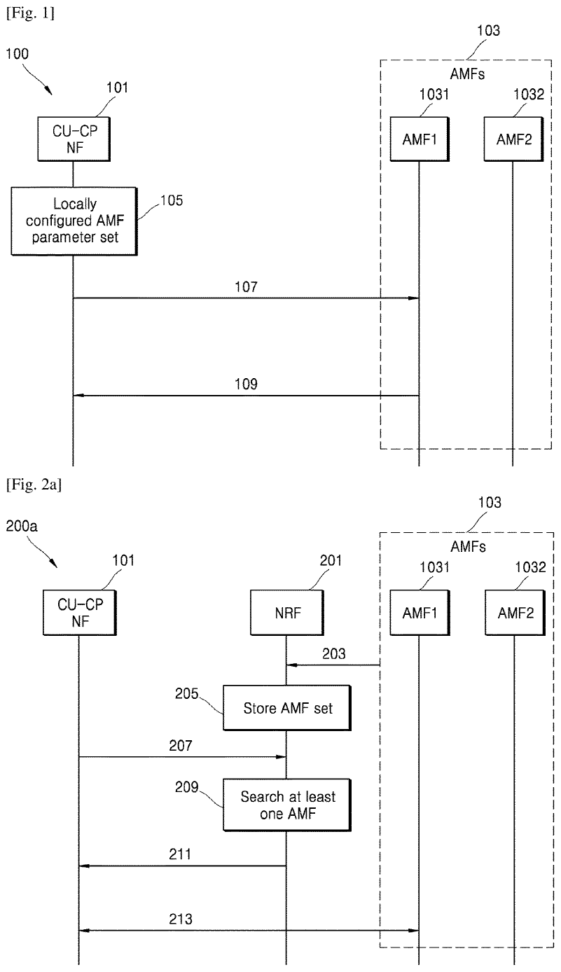

FIG. 1 illustrates an environment for NF selection for access and mobility management in a service-based architecture in accordance with an embodiment of the present disclosure.

In an embodiment, a CU-CP NF directly communicates with an AMF (also, referred as a target AMF) using locally configured AMF parameter set. In this embodiment, the CU-CP NF 101 selects the AMF using locally configured AMF parameter set when (or in case that) the CU-CP NF 101 receives a 6G Temporary Mobile Subscriber Identity (6G-TMSI) or a 6G Globally Unique AMF Identifier (6G-GUAMI) from a UE.

With reference to FIG. 1, the environment 100 comprises of the CU-CP NF 101, and AMFs pool/set 103. The AMFs pool/set 103 comprises a plurality of AMFs (also referred as AMF pool/set) i.e., AMF 1 1031, and AMF 2 1032. The CU-CP NF 101 comprises a processor and a memory (not shown in FIG. 1). The memory is communicatively coupled to the processor. The processor includes at least one data processor for NF selection for access and mobility management in a service-based architecture. The processor includes specialized processing units such as, without limitation, integrated system (bus) controllers, memory management control units, floating point units, graphics processing units, digital signal processing units, etc. The memory stores processor instructions which cause the processor to execute the instructions for NF selection for access and mobility management in the service-based architecture. The memory includes, without limitation, memory drives. The memory drives further include a drum, a magnetic disc drive, a magneto-optical drive, an optical drive, a RAID, solid-state memory devices, solid-state drives, etc.

The operation for NF selection for access and mobility management in the service-based architecture in accordance with the an embodiment of the present disclosure is explained with reference to FIG. 1.

The CU-CP NF 101 receives a 6G-TMSI or 6G-GUAMI from a UE (not shown in FIG. 1). Thereafter, the CU-CP NF 101, which is locally configured using an AMF parameter set to enable AMF selection at the CU-CP NF 101 at step 105. The AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE (e.g., Public Land Mobile Network (PLMN) identifier (ID) or Tracking Area Identifier (TAI) or geographical location or any other UE-specific location identifier), an availability of AMFs, and weight factor across the AMFs. Upon configuring, the CU-CP NF 101 transmits a service request to one of the AMF from the AMFs pool/set 103 i.e., to either AMF 1 1031 or AMF 2 1032. In this example, the CU-CP NF 101 transmits a service request to the AMF 1 1031 at step 107. One of the AMF from the AMFs pool/set 103 is selected by the CU-CP NF 101 using the AMF parameter set. The service request comprises the AMF parameter set. In response to the service request, the CU-CP NF 101 receives a service response from one of the AMF from the AMFs pool/set 103 i.e., AMF 1 1031 in this example, to establish a connection with the AMF 1 1031 for services at step 109. The steps 105 and 107 may be referred as a service request step and the step 109 may be referred as a service response step.

In the embodiment illustrated in FIG. 1, NF service consumer-based discovery and selection of the target NF may be provided. For example, the CU-CP NF 101 may need to be configured locally with AMF set information parameters to enable NF selection at CU-CP NF in case that there is no NG interface. The CU-CP NF 101 may directly send a service request to the target NF (e.g., AMF 1 1031) including the target AMF set information parameters. As a result, the CU-CP NF 101 may be able to establish the service request/response or session between the CU-CP NF and selected/target NF (e.g., AMF 1 1031).

The system and the method of the present disclosure for NF selection for access and mobility management in a service-based architecture in accordance with an embodiment is applicable to, but not limited to, 5G and 6G wireless communication network. The CU-CP NF 101 may be a 6G RAN module in the 6G wireless communication network.

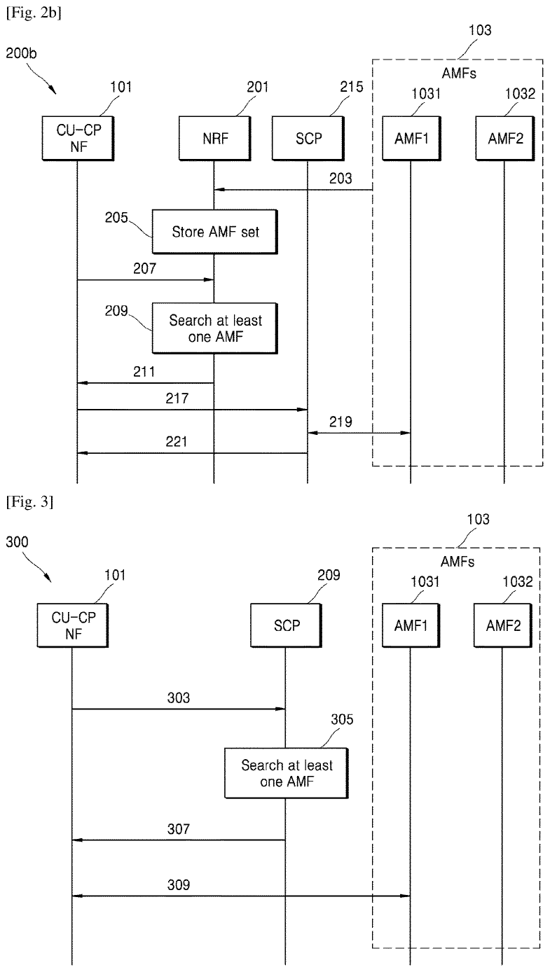

FIGS. 2a and 2b illustrate an environment for NF selection for access and mobility management in a service-based architecture in accordance with an embodiment of the present disclosure.

With reference to FIG. 2a, the environment 200a comprises of a CU-CP NF 101, a NRF 201, and AMFs pool/set 103. The AMFs pool/set 103 comprises a plurality of AMFs (also, referred as AMF pool/set) i.e., AMF 1 1031, and AMF 2 1032. The CU-CP NF 101 comprises a first processor and a first memory (not shown in FIG. 2a). The first memory is communicatively coupled to the first processor. The first processor includes at least one data processor for NF selection for access and mobility management in a service-based architecture. The first processor includes specialized processing units such as, without limitation, integrated system (bus) controllers, memory management control units, floating point units, graphics processing units, digital signal processing units, etc. The first memory stores processor instructions which cause the first processor to execute the instructions for NF selection for access and mobility management in the service-based architecture. The first memory includes, without limitation, memory drives. The memory drives further include a drum, a magnetic disc drive, a magneto-optical drive, an optical drive, a RAID, solid-state memory devices, solid-state drives, etc. The NRF 201 comprises a second processor and a second memory (not shown in FIG. 2a). The second memory is communicatively coupled to the second processor. The second processor include at least one data processor for NF selection for access and mobility management in a service-based architecture. The second processor includes specialized processing units such as, without limitation, integrated system (bus) controllers, memory management control units, floating point units, graphics processing units, digital signal processing units, etc. The second memory stores processor instructions which cause the second processor to execute the instructions for NF selection for access and mobility management in the service-based architecture. The second memory includes, without limitation, memory drives. The memory drives further include a drum, a magnetic disc drive, a magneto-optical drive, an optical drive, a RAID, solid-state memory devices, solid-state drives, etc.

In the embodiment illustrated in FIG. 2a, NRF based discovery and selection of the target NF may be provided. For example, the CU-CP NF 101 may register a service to the NRF 201, and after successful service registration, NRF 201 may perform the service discovery for the target NF. As a result, CU-CP NF 101 may be able to establish the service request/response or session between the CU-CP NF 101 and selected/target NF (For example AMF 1 1031).

In an embodiment, with reference to FIG. 2a, there are four scenarios for NF selection for access and mobility management in a service-based architecture. The operation of each of the four scenarios for NF selection for access and mobility management in the service-based architecture, which involves the NRF 201 is explained below.

First scenario: This scenario refers to when a UE provides no 6G-TMSI or 6G-GUAMI to the CU-CP NF 101.

The NRF 201 receives associated AMF details from the at least one AMF 103 at step 203. In detail, the NRF 201 receives the (associated) AMF details from the AMF 1 1031 of the AMFs pool/set 103 and the (associated) AMF details from the AMF 2 1032 of the AMFs (also, referred as AMF pool/set) 103. The AMF details comprise AMF names, a list of 6G-GUAMIs, an availability of AMFs, and weight factor across the AMFs. For example, the NRF 201 receives the (associated) AMF details from the AMF 1 1031 of the AMFs pool/set 103 and the (associated) AMF details from the AMF 2 1032 of the AMFs pool/set 103 using a Nnrf_NFManagement_NFRegister message. Thereafter, the NRF 201 stores the AMF details associated with the at least one AMF 103 at step 205. The CU-CP NF 101 transmits a NF discovery request to the NRF 201 at step 207. The NF discovery request is transmitted to the NRF 201 when a UE (not shown in FIG. 2a) provides no 6G-TMSI or 6G-GUAMI to the CU-CP NF 101. For example, the CU-CP NF 101 receives no 6G-TMSI or 6G-GUAMI from the UE. The NF discovery request comprises an AMF parameter set for an AMF selection. The AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs. For example, the CU-CP NF 101 transmits a Nnrf_AMFDiscovery_Request including the AMF parameter set to the NRF 201. For example, the Nnrf_AMFDiscovery_Request may include the AMF parameter set with no GUAMI. Upon receiving the NF discovery request, the NRF 201 selects at least one AMF 103 at step 209. In detail, the selecting the at least one AMF 103 upon receiving the NF discovery request involves the NRF 201 searching for the at least one AMF 103 using the AMF parameter set upon receiving the NF discovery request. Thereafter, the NRF 201 transmits a NF discovery response to the CU-CP NF 101 upon completing the selection for the at least one AMF 103 at step 211. The NF discovery response comprises of the at least one AMF 103. For example, the NRF 201 transmits a Nnrf_AMFDiscovery_Response message with at least one AMF 103. The CU-CP NF 101 may receive the NF discovery response (e.g., the Nnrf_AMFDiscovery_Response message) in response to the NF discovery request from the NRF. Subsequently, the CU-CP NF 101 establishes a connection with one of the at least one AMF 103 for services at step 213. In detail, establishing the connection with one of the at least one AMF 103 for services involves the CU-CP NF 101 selecting one of the at least one AMF 103 based on one or more factors in the AMF parameter set. The one or more factors include an AMF region identity, an AMF set identity, an NSSAI, local operator policies, an IAB indication, an NB-IoT RAT type, 6G CIoT features indicated in RRC signalling by a UE, a SNPN on boarding indication as indicated in the RRC signalling by the UE, a location of the UE, an availability of AMFs, and weight factor across the AMFs. For example, the CU-CP NF 101 subscribes to selected one of the at least one AMF 103 for services using a Namf_EventExposure_Subscribe message and the selected one of the at least one AMF 103 notifies or subscribes to the CU-CP NF 101 using a Namf_EventExposure_Notify message. In present example, the CU-CP NF 101 establishes the connection with the AMF 1 1031 for services. The steps 203, and 205 may be referred as service registration steps, the steps 207, 209, and 211 may be referred as service discovery steps and the step 213 may be referred as a service request and response step.

Second scenario: This scenario refers to when a UE provides non-usable 6G-TMSI or 6G-GUAMI to the CU-CP NF 101. In detail, the UE provides 6G-TMSI or 6G-GUAMI but routing information such as AMF set identity and an AMF region identity present in the 6G-TMSI or 6G-GUAMI is insufficient or not usable, for example, the UE provides 6G-GUAMI with an AMF region identity from a different region.

The NRF 201 receives associated AMF details from the at least one AMF 103 at step 203. In detail, the NRF 201 receives the (associated) AMF details from the AMF 1 1031 of the AMFs pool/set 103 and the (associated) AMF details from the AMF 2 1032 of the AMFs pool/set 103. The AMF details comprise AMF names, a list of 6G-GUAMIs, an availability of AMFs, and weight factor across the AMFs. For example, the NRF 201 receives the (associated) AMF details from the AMF 1 1031 of the AMFs pool/set 103 and the (associated) AMF details from the AMF 2 1032 of the AMFs pool/set 103 using a Nnrf_NFManagement_NFRegister message. Thereafter, the NRF 201 stores the AMF details associated with the at least one AMF 103 at step 205. The CU-CP NF 101 transmits a NF discovery request to the NRF 201 at step 207. The NF discovery request is transmitted to the NRF 201 when a UE (not shown in FIG. 2a) provides an insufficient or non-usable 6G-TMSI or 6G-GUAMI to the CU-CP NF 101. For example, the CU-CP NF 101 may receive a non-usable 6G-TMSI or 6G-GUAMI from the UE, or receive a 6G-GUAMI that is unavailable from the UE. The NF discovery request comprises an AMF parameter set for an AMF selection. The AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs. For example, the CU-CP NF 101 transmits a Nnrf_AMFDiscovery_Request including the AMF parameter set to the NRF 201. For example, the Nnrf_AMFDiscovery_Request may include the AMF parameter set with an insufficient and/or not usable 6G-GUAMI. Upon receiving the NF discovery request, the NRF 201 selects at least one AMF 103 at step 209. In detail, the selecting the at least one AMF 103 upon receiving the NF discovery request involves the NRF 201 searching for the at least one AMF 103 using the AMF parameter set upon receiving the NF discovery request. Thereafter, the NRF 201 transmits a NF discovery response to the CU-CP NF 101 upon completing the selection for the at least one AMF 103 at step 211. The NF discovery response comprises of the at least one AMF 103. For example, the NRF 201 transmits a Nnrf_AMFDiscovery_Response message with at least one AMF 103. Subsequently, the CU-CP NF 101 establishes a connection with one of the at least one AMF 103 for services at step 213. In detail, establishing the connection with one of the at least one AMF 103 for services involves the CU-CP NF 101 selecting one of the at least one AMF 103 based on one or more factors in the AMF parameter set. The one or more factors include an AMF region identity, an AMF set identity, an NSSAI, local operator policies, an IAB indication, an NB-IoT RAT type, 6G CIoT features indicated in RRC signalling by a UE, a SNPN on boarding indication as indicated in the RRC signalling by the UE, a location of the UE, an availability of AMFs, and weight factor across the AMFs. For example, the CU-CP NF 101 subscribes to selected one of the at least one AMF 103 for services using a Namf_EventExposure_Subscribe message and the selected one of the at least one AMF 103 notifies or subscribes to the CU-CP NF 101 using a Namf_EventExposure_Notify message. In present example, the CU-CP NF 101 establishes the connection with the AMF 1 1031 for services. The steps 203, and 205 may be referred as service registration steps, the steps 207, 209, and 211 may be referred as service discovery steps and the step 213 may be referred as a service request and response step.

Third scenario: This scenario refers to when the UE provides 6G-GUAMI to the CU-CP NF 101 that is unavailable. In detail, the UE provides 6G-GUAMI to the CU-CP NF 101 that indicates an AMF is unavailable, for example, due to AMF failure.

The NRF 201 receives associated AMF details from the at least one AMF 103 at step 203. In detail, the NRF 201 receives the (associated) AMF details from the AMF 1 1031 of the AMFs pool/set 103 and the (associated) AMF details from the AMF 2 1032 of the AMFs pool/set 103. The AMF details comprise AMF names, a list of 6G-GUAMIs, an availability of AMFs, and weight factor across the AMFs. For example, the NRF 201 receives the (associated) AMF details from the AMF 1 1031 of the AMFs pool/set 103 and the (associated) AMF details from the AMF 2 1032 of the AMFs pool/set 103 using a Nnrf_NFManagement_NFRegister message. Thereafter, the NRF 201 stores the AMF details associated with the at least one AMF 103 at step 205. At this stage, for example, if the AMF 2 1032 fails, the NRF 201 receives a failure notification from the AMF 2 1032 of the AMFs pool/set 103 using a Namf_Communication_FailureNotification message (not shown in FIG. 2a). This step is to indicate to the NRF 201 that the AMF 2 1032 is unavailable due to AMF failure. The CU-CP NF 101 transmits a NF discovery request to the NRF 201 at step 207. The NF discovery request is transmitted to the NRF 201 when a UE (not shown in FIG. 2a) provides 6G-GUAMI to the CU-CP NF 101 that is unavailable. The NF discovery request comprises an AMF parameter set for an AMF selection. The AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs. For example, the CU-CP NF 101 transmits a Nnrf_AMFDiscovery_Request including the AMF parameter set to the NRF 201. For example, the Nnrf_AMFDiscovery_Request may include the AMF parameter set with the GUAMI for the AMF (e.g., AMF 2 1032), which has failed due to any reason. Upon receiving the NF discovery request, the NRF 201 selects at least one AMF 103 at step 209. In detail, the searching the at least one AMF 103 using the AMF parameter set upon receiving the NF discovery request excludes the AMF 2 1032 that is non-working among the at least one AMF 103. Thereafter, the NRF 201 transmits a NF discovery response to the CU-CP NF 101 upon completing the selection for the at least one AMF 103 (excluding the AMF 2 1032) at step 211. The NF discovery response comprises of the at least one AMF 103 excluding the AMF 2 1032 that is non-working among the at least one AMF 103. For example, the NRF 201 transmits a Nnrf_AMFDiscovery_Response message with the at least one AMF 103 excluding the AMF 2 1032 that is non-working. Subsequently, the CU-CP NF 101 establishes a connection with one of the at least one AMF 103 for services at step 213. In detail, establishing the connection with one of the at least one AMF 103 for services involves the CU-CP NF 101 selecting one of the at least one AMF 103 based on one or more factors in the AMF parameter set. The one or more factors include an AMF region identity, an AMF set identity, an NSSAI, local operator policies, an IAB indication, an NB-IoT RAT type, 6G CIoT features indicated in RRC signalling by a UE, a SNPN on boarding indication as indicated in the RRC signalling by the UE, a location of the UE, an availability of AMFs, and weight factor across the AMFs. For example, the CU-CP NF 101 subscribes to selected one of the at least one AMF 103 for services using a Namf_EventExposure_Subscribe message and the selected one of the at least one AMF 103 notifies or subscribes to the CU-CP NF 101 using a Namf_EventExposure_Notify message. In one embodiment, after transmitting or subscribing the Namf_EventExposure_Subscribe message by the CU-CP NF 101 and before notifying or subscribing to the CU-CP NF 101 using a Namf_EventExposure_Notify message, the AMF 1 1031 may request UE context from the AMF 2 1032 (i.e., not working) via a Namf_Communication_UEContextTransfer Request message and the AMF 2 1032 may provide the UE context to the AMF 1 1031 via Namf_Communication_UEContextTransfer Response message (not shown in FIG. 2a). In present example, the CU-CP NF 101 establishes the connection with the AMF 1 1031 for services while the AMF 2 1032 is excluded as it is non-working. The steps 203, and 205 may be referred as service registration steps, the steps 207, 209, and 211 may be referred as service discovery steps and the step 213 may be referred as a service request and response step.

Fourth scenario: This scenario refers to when the CU-CP NF 101 is configured to enforce selection of an AMF based on a country a UE is currently located.

The NRF 201 receives associated AMF details from the at least one AMF 103 at step 203. In detail, the NRF 201 receives the (associated) AMF details from the AMF 1 1031 of the AMFs pool/set 103 and the (associated) AMF details from the AMF 2 1032 of the AMFs pool/set 103. The AMF details comprise AMF names, a list of 6G-GUAMIs, an availability of AMFs, and weight factor across the AMFs. For example, the NRF 201 receives the (associated) AMF details from the AMF 1 1031 of the AMFs pool/set 103 and the (associated) AMF details from the AMF 2 1032 of the AMFs pool/set 103 using a Nnrf_NFManagement_NFRegister message. The AMF 1 1031 of the AMFs pool/set 103 is serving a same country where the UE is currently located whereas the AMF 2 1032 of the AMFs pool/set 103 is serving a different country than where the UE is currently located. Thereafter, the NRF 201 stores the AMF details associated with the at least one AMF 103 at step 205. The CU-CP NF 101 transmits a NF discovery request to the NRF 201 at step 207. The NF discovery request comprises an AMF parameter set for an AMF selection. The AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs. For example, the CU-CP NF 101 transmits a Nnrf_AMFDiscovery_Request including the AMF parameter set to the NRF 201. For example, the Nnrf_AMFDiscovery_Request may include AMF set information (or the AMF parameter set) with the UE location for at least one AMF 103. Upon receiving the NF discovery request, the NRF 201 selects at least one AMF 103 at step 209. In detail, the searching the at least one AMF 103 using the AMF parameter set upon receiving the NF discovery request excludes the AMF 2 1032 among the at least one AMF 103 that is serving a different country than where the UE is currently located. Thereafter, the NRF 201 transmits a NF discovery response to the CU-CP NF 101 upon completing the selection for the at least one AMF 103 (excluding the AMF 2 1032) at step 211. The NF discovery response comprises of the at least one AMF 103 excluding the AMF 2 1032 that is serving a different country among the at least one AMF 103. For example, the NRF 201 transmits a Nnrf_AMFDiscovery_Response message with at least one AMF 103 excluding the AMF 2 1032 that is serving a different country. Subsequently, the CU-CP NF 101 establishes a connection with one of the at least one AMF 103 for services at step 213. In detail, establishing the connection with one of the at least one AMF 103 for services involves the CU-CP NF 101 selecting one of the at least one AMF 103 based on one or more factors in the AMF parameter set. The one or more factors include an AMF region identity, an AMF set identity, an NSSAI, local operator policies, an IAB indication, an NB-IoT RAT type, 6G CIoT features indicated in RRC signalling by a UE, a SNPN on boarding indication as indicated in the RRC signalling by the UE, a location of the UE, an availability of AMFs, and weight factor across the AMFs. For example, the CU-CP NF 101 subscribes to selected one of the at least one AMF 103 for services using a Namf_EventExposure_Subscribe message and the selected one of the at least one AMF 103 notifies or subscribes to the CU-CP NF 101 using a Namf_EventExposure_Notify message. In one embodiment, after transmitting or subscribing the Namf_EventExposure_Subscribe message by the CU-CP NF 101 and before notifying or subscribing to the CU-CP NF 101 using a Namf_EventExposure_Notify message, the AMF 1 1031 may request UE context from the AMF 2 1032 (i.e., serving a different country) via a Namf_Communication_UEContextTransfer Request message and the AMF 2 1032 may provide the UE context to the AMF 1 1031 via Namf_Communication_UEContextTransfer Response message (not shown in FIG. 2a). In present example, the CU-CP NF 101 establishes the connection with the AMF 1 1031 for services while the AMF 2 1032 is excluded as it is serving a different country. The steps 203, and 205 may be referred as service registration steps, the steps 207, 209, and 211 may be referred as service discovery steps and the step 213 may be referred as a service request and response step.

With reference to FIG. 2b, the environment 200b comprises of a CU-CP NF 101, a NRF 201, a SCP 215, and AMFs pool/set 103. The AMFs pool/set 103 comprises a plurality of AMFs (also, referred as AMFs pool/set) i.e., AMF 1 1031, and AMF 2 1032. The CU-CP NF 101 comprises a first processor and a first memory (not shown in FIG. 2b). The first memory is communicatively coupled to the first processor. The first processor includes at least one data processor for NF selection for access and mobility management in a service-based architecture. The first processor includes specialized processing units such as, without limitation, integrated system (bus) controllers, memory management control units, floating point units, graphics processing units, digital signal processing units, etc. The first memory stores processor instructions which cause the first processor to execute the instructions for NF selection for access and mobility management in the service-based architecture. The first memory includes, without limitation, memory drives. The memory drives further include a drum, a magnetic disc drive, a magneto-optical drive, an optical drive, a RAID, solid-state memory devices, solid-state drives, etc. The NRF 201 comprises a second processor and a second memory (not shown in FIG. 2b). The second memory is communicatively coupled to the second processor. The second processor include at least one data processor for NF selection for access and mobility management in a service-based architecture. The second processor includes specialized processing units such as, without limitation, integrated system (bus) controllers, memory management control units, floating point units, graphics processing units, digital signal processing units, etc. The second memory stores processor instructions which cause the second processor to execute the instructions for NF selection for access and mobility management in the service-based architecture. The second memory includes, without limitation, memory drives. The memory drives further include a drum, a magnetic disc drive, a magneto-optical drive, an optical drive, a RAID, solid-state memory devices, solid-state drives, etc. The SCP 215 comprises a third processor and a third memory (not shown in FIG. 2b). The third memory is communicatively coupled to the third processor. The third processor include at least one data processor for NF selection for access and mobility management in a service-based architecture. The third processor includes specialized processing units such as, without limitation, integrated system (bus) controllers, memory management control units, floating point units, graphics processing units, digital signal processing units, etc. The third memory stores processor instructions which cause the third processor to execute the instructions for NF selection for access and mobility management in the service-based architecture. The third memory includes, without limitation, memory drives. The memory drives further include a drum, a magnetic disc drive, a magneto-optical drive, an optical drive, a RAID, solid-state memory devices, solid-state drives, etc.

In the embodiment illustrated in FIG. 2b, NRF based discovery and service request of the target NF via the SCP may be provided. For example, the CU-CP NF 101 may register a service to the NRF 201, and after successful service registration, NRF 201 may perform the service discovery for the target NF. Once the discovery procedure is completed, SCP 215 may send the service request to the target NF. As a result, CU-CP NF 101 may be able to establish the service request/response or session between the CU-CP NF 101 and selected/target NF (e.g. AMF 1 1031).

In an embodiment, with reference to FIG. 2b, there are four scenarios for NF selection for access and mobility management in a service-based architecture. The operation of each of the four scenarios for NF selection for access and mobility management in the service-based architecture, which involves the NRF 201 and the SCP 215 is explained below.

First scenario: This scenario refers to when a UE provides no 6G-TMSI or 6G-GUAMI to the CU-CP NF 101.

The NRF 201 receives associated AMF details from the at least one AMF 103 at step 203. In detail, the NRF 201 receives the (associated) AMF details from the AMF 1 1031 of the AMFs pool/set 103 and the (associated) AMF details from the AMF 2 1032 of the AMFs pool/set 103. The AMF details comprise AMF names, a list of 6G-GUAMIs, an availability of AMFs, and weight factor across the AMFs. For example, the NRF 201 receives the (associated) AMF details from the AMF 1 1031 of the AMFs pool/set 103 and the (associated) AMF details from the AMF 2 1032 of the AMFs pool/set 103 using a Nnrf_NFManagement_NFRegister message. Thereafter, the NRF 201 stores the AMF details associated with the at least one AMF 103 at step 205. The CU-CP NF 101 transmits a NF discovery request to the NRF 201 at step 207. The NF discovery request is transmitted to the NRF 201 when a UE (not shown in FIG. 2b) provides no 6G-TMSI or 6G-GUAMI to the CU-CP NF 101. The NF discovery request comprises an AMF parameter set for an AMF selection. The AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs. For example, the CU-CP NF 101 transmits a Nnrf_AMFDiscovery_Request including the AMF parameter set to the NRF 201. For example, the Nnrf_AMFDiscovery_Request may include AMF set information (or the AMF parameter set) with no GUAMI. Upon receiving the NF discovery request, the NRF 201 selects at least one AMF 103 at step 209. In detail, the selecting the at least one AMF 103 upon receiving the NF discovery request involves the NRF 201 searching for the at least one AMF 103 using the AMF parameter set upon receiving the NF discovery request. Thereafter, the NRF 201 transmits a NF discovery response to the CU-CP NF 101 upon completing the selection for the at least one AMF 103 at step 211. The NF discovery response comprises of the at least one AMF 103. For example, the NRF 201 transmits a Nnrf_AMFDiscovery_Response message with at least one AMF 103. Subsequently, the CU-CP NF 101 establishes a connection with one of the at least one AMF 103 for services. In detail, establishing the connection with one of the at least one AMF 103 for services involves the CU-CP NF 101 selecting one of the at least one AMF 103 based on one or more factors in the AMF parameter set and transmitting a service request to the SCP 215 to establish the connection for services with the selected AMF via the SCP 215 at step 217. The one or more factors include an AMF region identity, an AMF set identity, an NSSAI, local operator policies, an IAB indication, an NB-IoT RAT type, 6G CIoT features indicated in RRC signalling by a UE, a SNPN on boarding indication as indicated in the RRC signalling by the UE, a location of the UE, an availability of AMFs, and weight factor across the AMFs. The CU-CP NF 101 provides an AMF region identity, or an AMF set identity of the selected AMF to the SCP 215. For example, the CU-CP NF 101 subscribes to the SCP 215 using a Namf_EventExposure_Subscribe message. Subsequently, the SCP 215 forwards or transmits the service request to the selected AMF at step 219. For example, the SCP 215 forwards or transmits the service request to the selected AMF using a Namf_EventExposure_Subscribe message. Thereafter, the SCP 215 transfers or transmits the service response from the selected AMF (received at step 219) to the CU-CP NF 101 at step 221. For example, the SCP 215 receives the service response from the selected AMF using a Namf_EventExposure_Notify message and forwards or transmits the service response to the CU-CP NF 101 using a Namf_EventExposure_Notify message. In present example, the CU-CP NF 101 establishes the connection with the AMF 1 1031 via the SCP 215 for services. The steps 203, and 205 may be referred as service registration steps, the steps 207, 209, and 211 may be referred as service discovery steps and the steps 217, 219 and 221 may be referred as a service request and response step.

Second scenario: This scenario refers to when a UE provides non-usable 6G-TMSI or 6G-GUAMI to the CU-CP NF 101. In detail, the UE provides 6G-TMSI or 6G-GUAMI but routing information such as AMF set identity and an AMF region identity present in the 6G-TMSI or 6G-GUAMI is insufficient or not usable, for example, the UE provides 6G-GUAMI with an AMF region identity from a different region.

The NRF 201 receives associated AMF details from the at least one AMF 103 at step 203. In detail, the NRF 201 receives the (associated) AMF details from the AMF 1 1031 of the AMFs pool/set 103 and the (associated) AMF details from the AMF 2 1032 of the AMFs pool/set 103. The AMF details comprise AMF names, a list of 6G-GUAMIs, an availability of AMFs, and weight factor across the AMFs. For example, the NRF 201 receives the (associated) AMF details from the AMF 1 1031 of the AMFs pool/set 103 and the (associated) AMF details from the AMF 2 1032 of the AMFs pool/set 103 using a Nnrf_NFManagement_NFRegister message. Thereafter, the NRF 201 stores the AMF details associated with the at least one AMF 103 at step 205. The CU-CP NF 101 transmits a NF discovery request to the NRF 201 at step 207. The NF discovery request is transmitted to the NRF 201 when a UE (not shown in FIG. 2b) provides an insufficient or non-usable 6G-TMSI or 6G-GUAMI to the CU-CP NF 101. The NF discovery request comprises an AMF parameter set for an AMF selection. The AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs. For example, the CU-CP NF 101 transmits a Nnrf_AMFDiscovery_Request including the AMF parameter set to the NRF 201. For example, the Nnrf_AMFDiscovery_Request may include AMF set information (or the AMF parameter set) with insufficient and/or not usable 6G-GUAMI. Upon receiving the NF discovery request, the NRF 201 selects at least one AMF 103 at step 209. In detail, the selecting the at least one AMF 103 upon receiving the NF discovery request involves the NRF 201 searching for the at least one AMF 103 using the AMF parameter set upon receiving the NF discovery request. Thereafter, the NRF 201 transmits a NF discovery response to the CU-CP NF 101 upon completing the selection for the at least one AMF 103 at step 211. The NF discovery response comprises of the at least one AMF 103. For example, the NRF 201 transmits a Nnrf_AMFDiscovery_Response message with at least one AMF 103. Subsequently, the CU-CP NF 101 establishes a connection with one of the at least one AMF 103 for services. In detail, establishing the connection with one of the at least one AMF 103 for services involves the CU-CP NF 101 selecting one of the at least one AMF 103 based on one or more factors in the AMF parameter set and transmitting a service request to the SCP 215 to establish the connection for services with the selected AMF via the SCP 215 at step 217. The one or more factors include an AMF region identity, an AMF set identity, an NSSAI, local operator policies, an IAB indication, an NB-IoT RAT type, 6G CIoT features indicated in RRC signalling by a UE, a SNPN on boarding indication as indicated in the RRC signalling by the UE, a location of the UE, an availability of AMFs, and weight factor across the AMFs. The CU-CP NF 101 provides an AMF region identity, or an AMF set identity of the selected AMF to the SCP 215. For example, the CU-CP NF 101 subscribes to the SCP 215 using a Namf_EventExposure_Subscribe message. Subsequently, the SCP 215 forwards or transmits the service request to the selected AMF at step 219. For example, the SCP 215 forwards or transmits the service request to the selected AMF using a Namf_EventExposure_Subscribe message. Thereafter, the SCP 215 transfers or transmits the service response from the selected AMF (received at step 219) to the CU-CP NF 101 at step 221. For example, the SCP 215 receives the service response from the selected AMF using a Namf_EventExposure_Notify message and forwards or transmits the service response to the CU-CP NF 101 using a Namf_EventExposure_Notify message. In present example, the CU-CP NF 101 establishes the connection with the AMF 1 1031 via the SCP 215 for services. The steps 203, and 205 may be referred as service registration steps, the steps 207, 209, and 211 may be referred as service discovery steps and the steps 217, 219 and 221 may be referred as a service request and response step.

Third scenario: This scenario refers to when the UE provides 6G-GUAMI to the CU-CP NF 101 that is unavailable. In detail, the UE provides 6G-GUAMI to the CU-CP NF 101 that indicates an AMF is unavailable, for example, due to AMF failure.

The NRF 201 receives associated AMF details from the at least one AMF 103 at step 203. In detail, the NRF 201 receives the (associated) AMF details from the AMF 1 1031 of the AMFs pool/set 103 and the (associated) AMF details from the AMF 2 1032 of the AMFs pool/set 103. The AMF details comprise AMF names, a list of 6G-GUAMIs, an availability of AMFs, and weight factor across the AMFs. For example, the NRF 201 receives the (associated) AMF details from the AMF 1 1031 of the AMFs pool/set 103 and the (associated) AMF details from the AMF 2 1032 of the AMFs pool/set 103 using a Nnrf_NFManagement_NFRegister message. Thereafter, the NRF 201 stores the AMF details associated with the at least one AMF 103 at step 205. At this stage, for example, if the AMF 2 1032 fails, the NRF 201 receives a failure notification from the AMF 2 1032 of the AMFs pool/set 103 using a Namf_Communication_FailureNotification message (not shown in FIG. 2b). This step is to indicate to the NRF 201 that the AMF 2 1032 is unavailable due to AMF failure. The CU-CP NF 101 transmits a NF discovery request to the NRF 201 at step 207. The NF discovery request is transmitted to the NRF 201 when a UE (not shown in FIG. 2b) provides 6G-GUAMI to the CU-CP NF 101 that is unavailable. The NF discovery request comprises an AMF parameter set for an AMF selection.

The AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs. For example, the CU-CP NF 101 transmits a Nnrf_AMFDiscovery_Request message including the AMF parameter set to the NRF 201. For example, the Nnrf_AMFDiscovery_Request may include AMF set information (or the AMF parameter set) with the GUAMI for the AMF, which has failed due to any reason (e.g., AMF 2 1032). Upon receiving the NF discovery request, the NRF 201 selects at least one AMF 103 at step 209. In detail, the searching the at least one AMF 103 using the AMF parameter set upon receiving the NF discovery request excludes the AMF 2 1032 that is non-working among the at least one AMF 103. Thereafter, the NRF 201 transmits a NF discovery response to the CU-CP NF 101 upon completing the selection for the at least one AMF 103 (excluding the AMF 2 1032) at step 211. The NF discovery response comprises of the at least one AMF 103 excluding the AMF 2 1032 that is non-working among the at least one AMF 103. For example, the NRF 201 transmits a Nnrf_AMFDiscovery_Response message with at least one AMF 103 excluding the AMF 2 1032 that is non-working. Subsequently, the CU-CP NF 101 establishes a connection with one of the at least one AMF 103 for services. In detail, establishing the connection with one of the at least one AMF 103 for services involves the CU-CP NF 101 selecting one of the at least one AMF 103 based on one or more factors in the AMF parameter set and transmitting a service request to the SCP 215 to establish the connection for services with the selected AMF via the SCP 215 at step 217. The one or more factors include an AMF region identity, an AMF set identity, an NSSAI, local operator policies, an IAB indication, an NB-IoT RAT type, 6G CIoT features indicated in RRC signalling by a UE, a SNPN on boarding indication as indicated in the RRC signalling by the UE, a location of the UE, an availability of AMFs, and weight factor across the AMFs. The CU-CP NF 101 provides an AMF region identity, or an AMF set identity of the selected AMF to the SCP 215. For example, the CU-CP NF 101 subscribes to the SCP 215 using a Namf_EventExposure_Subscribe message. Subsequently, the SCP 215 forwards or transmits the service request to the selected AMF at step 219. For example, the SCP 215 forwards or transmits the service request to the selected AMF using a Namf_EventExposure_Subscribe message. In one embodiment, at this stage, the AMF 1 1031 may request UE context from the AMF 2 1032 (i.e., not working) via a Namf_Communication_UEContextTransfer Request message and the AMF 2 1032 may provide the UE context to the AMF 1 1031 via Namf_Communication_UEContextTransfer Response message. Thereafter, the SCP 215 transfers or transmits the service response from the selected AMF (received at step 219) to the CU-CP NF 101 at step 221. For example, the SCP 215 receives the service response from the selected AMF using a Namf_EventExposure_Notify message and forwards or transmits the service response to the CU-CP NF 101 using a Namf_EventExposure_Notify message. In present example, the CU-CP NF 101 establishes the connection with the AMF 1 1031 via the SCP 215 for services while the AMF 2 1032 is excluded as it is non-working. The steps 203, and 205 may be referred as service registration steps, the steps 207, 209, and 211 may be referred as service discovery steps and the steps 217, 219 and 221 may be referred as a service request and response step.

Fourth scenario: This scenario refers to when the CU-CP NF 101 is configured to enforce selection of an AMF based on a country a UE is currently located.

The NRF 201 receives associated AMF details from the at least one AMF 103 at step 203. In detail, the NRF 201 receives the (associated) AMF details from the AMF 1 1031 of the AMFs pool/set 103 and the (associated) AMF details from the AMF 2 1032 of the AMFs pool/set 103. The AMF details comprise AMF names, a list of 6G-GUAMIs, an availability of AMFs, and weight factor across the AMFs. For example, the NRF 201 receives the (associated) AMF details from the AMF 1 1031 of the AMFs pool/set 103 and the (associated) AMF details from the AMF 2 1032 of the AMFs pool/set 103 using a Nnrf_NFManagement_NFRegister message. The AMF 1 1031 of the AMFs pool/set 103 is serving a same country where the UE is currently located whereas the AMF 2 1032 of the AMFs pool/set 103 is serving a different country than where the UE is currently located. Thereafter, the NRF 201 stores the AMF details associated with the at least one AMF 103 at step 205. The CU-CP NF 101 transmits a NF discovery request to the NRF 201 at step 207. The NF discovery request comprises an AMF parameter set for an AMF selection. The AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs. For example, the CU-CP NF 101 transmits a Nnrf_AMFDiscovery_Request including the AMF parameter set to the NRF 201. For example, the Nnrf_AMFDiscovery_Request may include AMF set information (or the AMF parameter set) with the UE location for at least one AMF 103. Upon receiving the NF discovery request, the NRF 201 selects at least one AMF 103 at step 209. In detail, the searching the at least one AMF 103 using the AMF parameter set upon receiving the NF discovery request excludes the AMF 2 1032 among the at least one AMF 103 that is serving a different country than where the UE is currently located.

Thereafter, the NRF 201 transmits a NF discovery response to the CU-CP NF 101 upon completing the selection for the at least one AMF 103 (excluding the AMF 2 1032) at step 211. The NF discovery response comprises of the at least one AMF 103 excluding the AMF 2 1032 that is serving a different country among the at least one AMF 103. For example, the NRF 201 transmits a Nnrf_AMFDiscovery_Response message with at least one AMF 103 excluding the AMF 2 1032 that is serving a different country. Subsequently, the CU-CP NF 101 establishes a connection with one of the at least one AMF 103 for services. In detail, establishing the connection with one of the at least one AMF 103 for services involves the CU-CP NF 101 selecting one of the at least one AMF 103 based on one or more factors in the AMF parameter set and transmitting a service request to the SCP 215 to establish the connection for services with the selected AMF via the SCP 215 at step 217. The one or more factors include an AMF region identity, an AMF set identity, an NSSAI, local operator policies, an IAB indication, an NB-IoT RAT type, 6G CIoT features indicated in RRC signalling by a UE, a SNPN on boarding indication as indicated in the RRC signalling by the UE, a location of the UE, an availability of AMFs, and weight factor across the AMFs. The CU-CP NF 101 provides an AMF region identity, or an AMF set identity of the selected AMF to the SCP 215. For example, the CU-CP NF 101 subscribes to the SCP 215 using a Namf_EventExposure_Subscribe message. Subsequently, the SCP 215 forwards or transmits the service request to the selected AMF at step 219. For example, the SCP 215 forwards or transmits the service request to the selected AMF using a Namf_EventExposure_Subscribe message. In one embodiment, at this stage, the AMF 1 1031 may request UE context from the AMF 2 1032 (i.e., serving a different country) via a Namf_Communication_UEContextTransfer Request message and the AMF 2 1032 may provide the UE context to the AMF 1 1031 via Namf_Communication_UEContextTransfer Response message. Thereafter, the SCP 215 transfers or transmits the service response from the selected AMF (received at step 219) to the CU-CP NF 101 at step 221. For example, the SCP 215 receives the service response from the selected AMF using a Namf_EventExposure_Notify message and forwards or transmits the service response to the CU-CP NF 101 using a Namf_EventExposure_Notify message. In present example, the CU-CP NF 101 establishes the connection with the AMF 1 1031 via the SCP 215 for services while the AMF 2 1032 is excluded as it is serving a different country. The steps 203, and 205 may be referred as service registration steps, the steps 207, 209, and 211 may be referred as service discovery steps and the steps 217, 219 and 221 may be referred as a service request and response step.

The system and the method of the present disclosure for NF selection for access and mobility management in a service-based architecture in accordance with an embodiment is applicable to, but not limited to, 5G and 6G wireless communication network. The CU-CP NF 101 may be a 6G RAN module in the 6G wireless communication network.

FIG. 3 illustrates an environment for NF selection for access and mobility management in a service-based architecture in accordance with an embodiment of the present disclosure.

In an embodiment, a CU-CP NF 101 delegates AMF discovery to a SCP 215. The SCP 215 selects an AMF (also, referred as a target or a selected AMF) using a AMF parameter set. In this embodiment, the CU-CP NF 101 communicates with the AMF selected by the SCP 215 when a UE provides no 6G-TMSI or 6G-GUAMI to the CU-CP NF 101.

With reference to FIG. 3, the environment 300 comprises of a CU-CP NF 101, a SCP 215, and AMFs pool/set 103. The AMFs pool/set 103 comprises a plurality of AMFs (also, referred as AMFs pool/set) i.e., AMF 1 1031, and AMF 2 1032. The CU-CP NF 101 comprises a first processor and a first memory (not shown in FIG. 3). The first memory is communicatively coupled to the first processor. The first processor includes at least one data processor for NF selection for access and mobility management in a service-based architecture. The first processor includes specialized processing units such as, without limitation, integrated system (bus) controllers, memory management control units, floating point units, graphics processing units, digital signal processing units, etc. The first memory stores processor instructions which cause the first processor to execute the instructions for NF selection for access and mobility management in the service-based architecture. The first memory includes, without limitation, memory drives. The memory drives further include a drum, a magnetic disc drive, a magneto-optical drive, an optical drive, a RAID, solid-state memory devices, solid-state drives, etc. The SCP 215 comprises a third processor and a third memory (not shown in FIG. 3). The third memory is communicatively coupled to the third processor. The third processor include at least one data processor for NF selection for access and mobility management in a service-based architecture. The third processor includes specialized processing units such as, without limitation, integrated system (bus) controllers, memory management control units, floating point units, graphics processing units, digital signal processing units, etc. The third memory stores processor instructions which cause the third processor to execute the instructions for NF selection for access and mobility management in the service-based architecture. The third memory includes, without limitation, memory drives. The memory drives further include a drum, a magnetic disc drive, a magneto-optical drive, an optical drive, a RAID, solid-state memory devices, solid-state drives, etc.

The operation for NF selection for access and mobility management in the service-based architecture in accordance with an embodiment of the present disclosure is explained with reference to FIG. 3. In the embodiment illustrated in FIG. 3, delegated discovery and associated selection of the target NF may be provided. For example, CU-CP NF 101 may delegate the discovery services for discovering the target NF, to the SCP 209. The SCP 209 may perform the service discovery and NF selection procedure. As a result, CU-CP NF 101 may be able to establish the service request/response or session between the CU-CP NF 101 and selected/target NF (e.g., AMF 1 1031).

The CU-CP NF 101 transmits a NF discovery request to the SCP 215 at step 303. The NF discovery request is transmitted to the SCP 215 when a UE provides no 6G-TMSI or 6G-GUAMI to the CU-CP NF 101. The NF discovery request comprises an AMF parameter set for an AMF selection. The AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs. For example, the CU-CP NF 101 transmits a Nscp_NFDiscovery_Request message including the AMF parameter set to the SCP 215. For example, the Nnrf_AMFDiscovery_Request may include AMF set information (or the AMF parameter set) without 6G-GUAMI. Upon receiving the NF discovery request, the SCP 215 selects at least one AMF 103 at step 305. In detail, the selecting the at least one AMF 103 upon receiving the NF discovery request involves the SCP 215 searching for the at least one AMF 103 using the AMF parameter set upon receiving the NF discovery request. Thereafter, the SCP 215 transmits a NF discovery response to the CU-CP NF 101 upon completing the selection for the at least one AMF 103 at step 307. The NF discovery response comprises at least one AMF 103. For example, the SCP 215 transmits a Nscp_NFDiscovery_Response message with at least one AMF 103. Subsequently, the CU-CP NF 101 establishes a connection with one of the at least one AMF 103 for services at step 309. In detail, establishing the connection with one of the at least one AMF 103 for services involves the CU-CP NF 101 selecting one of the at least one AMF 103 based on one or more factors in the AMF parameter set. The one or more factors include an AMF region identity, an AMF set identity, an NSSAI, local operator policies, an IAB indication, an NB-IoT RAT type, 6G CIoT features indicated in RRC signalling by a UE, a SNPN on boarding indication as indicated in the RRC signalling by the UE, a location of the UE, an availability of AMFs, and weight factor across the AMFs. For example, the CU-CP NF 101 subscribes to selected one of the at least one AMF 103 for services using a Namf_EventExposure_Subscribe message and the selected one of the at least one AMF 103 notifies or subscribes to the CU-CP NF 101 using a Namf_EventExposure_Notify message. In present example, the CU-CP NF 101 establishes the connection with the AMF 1 1031 for services. The steps 303, 305, and 307 may be referred as a service discovery step and the step 309 may be referred as a service request and response step.

The system and the method of the present disclosure for NF selection for access and mobility management in a service-based architecture in accordance with an embodiment is applicable to, but not limited to, 5G and 6G wireless communication network. The CU-CP NF 101 may be a 6G RAN module in the 6G wireless communication network.

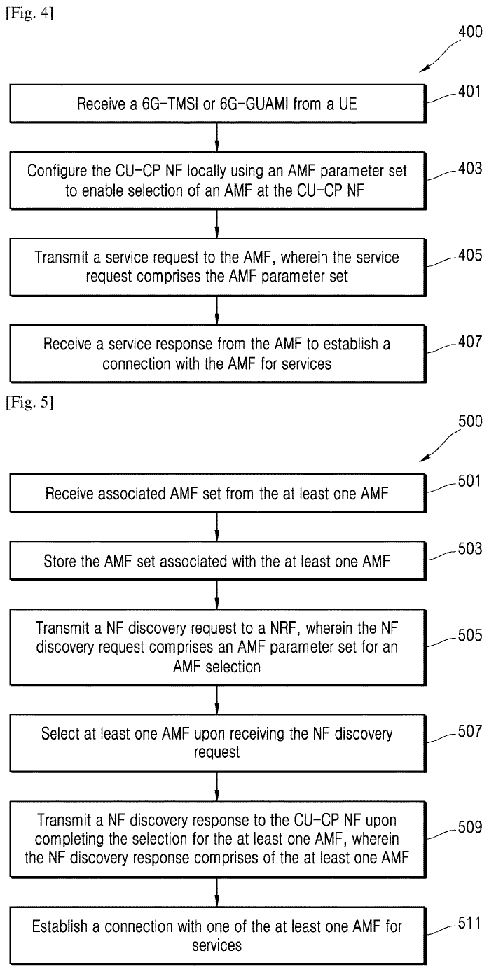

FIG. 4 illustrate a flowchart showing a method for NF selection for access and mobility management in a service-based architecture in accordance with an embodiment of the present disclosure.

As illustrated in FIG. 4, the method 400 includes one or more operation steps for access and mobility management in a service-based architecture in accordance with an embodiment of the present disclosure. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method operation steps can be combined in any order to implement the method. Additionally, individual operation steps may be deleted from the methods without departing from the scope of the subject matter described herein. Furthermore, the method can be implemented in any suitable hardware, software, firmware, or combination thereof.

At operation step 401, the CU-CP NF 101 receives a 6G-TMSI or 6G-GUAMI from a UE.

At operation step 403, the CU-CP NF 101 configures the CU-CP NF 101 locally using an AMF parameter set to enable selection of an AMF at the CU-CP NF 101. The AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs.

At operation step 405, the CU-CP NF 101 transmits a service request to the AMF 1031. The service request comprises the AMF parameter set.

At operation step 407, the CU-CP NF 101 receives a service response from the AMF 1031 to establish a connection with the AMF 1031 for services.

FIG. 5 illustrate a flowchart showing a method for NF selection for access and mobility management in a service-based architecture in accordance with an embodiment of the present disclosure.

As illustrated in FIG. 5, the method 500 includes one or more operation steps for access and mobility management in a service-based architecture in accordance with an embodiment of the present disclosure. The method 400 may be described in the general context of computer executable instructions. Generally, computer executable instructions can include routines, programs, objects, components, data structures, procedures, modules, and functions, which perform particular functions or implement particular abstract data types.

The order in which the method 500 is described is not intended to be construed as a limitation, and any number of the described method operation steps can be combined in any order to implement the method. Additionally, individual operation steps may be deleted from the methods without departing from the scope of the subject matter described herein. Furthermore, the method can be implemented in any suitable hardware, software, firmware, or combination thereof.

At operation step 501, the NRF 201 receives associated AMF details from the at least one AMF 103. The AMF details comprise an AMF name, a list of 6G-GUAMIs, at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs.

At operation step 503, the NRF 201 stores the AMF details associated with the at least one AMF 103.

At operation step 505, the CU-CP NF 101 transmits a NF discovery request to the NRF. The NF discovery request comprises an AMF parameter set for an AMF selection. The AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs.

At operation step 507, the NRF 201 selects at least one AMF 103 upon receiving the NF discovery request.

At operation step 509, the NRF 201 transmits a NF discovery response to the CU-CP NF 101 upon completing the selection for the at least one AMF 103. The NF discovery response comprises of the at least one AMF 103.

At operation step 511, the CU-CP NF 101 establishes a connection with one of the at least one AMF 103 for services.

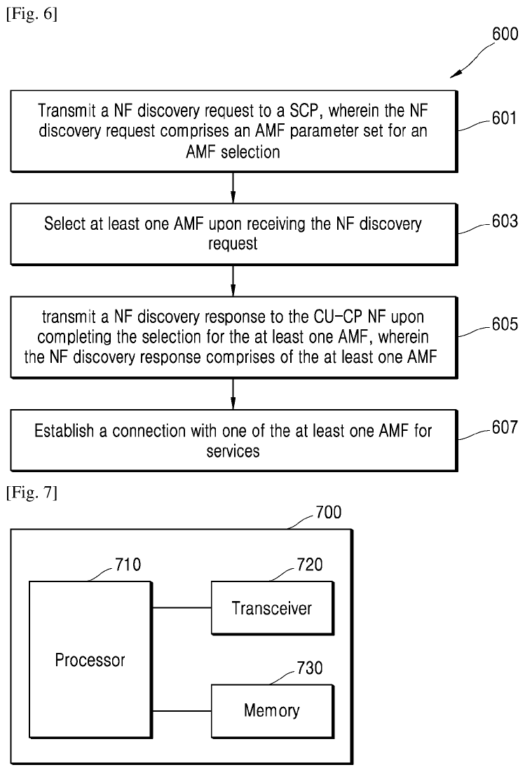

FIG. 6 illustrate a flowchart showing a method for NF selection for access and mobility management in a service-based architecture in accordance with an embodiment of the present disclosure.

As illustrated in FIG. 6, the method 600 includes one or more operation steps for access and mobility management in a service-based architecture in accordance with an embodiment of the present disclosure. The method 600 may be described in the general context of computer executable instructions. Generally, computer executable instructions can include routines, programs, objects, components, data structures, procedures, modules, and functions, which perform particular functions or implement particular abstract data types.

The order in which the method 600 is described is not intended to be construed as a limitation, and any number of the described method operation steps can be combined in any order to implement the method. Additionally, individual operation steps may be deleted from the methods without departing from the scope of the subject matter described herein. Furthermore, the method can be implemented in any suitable hardware, software, firmware, or combination thereof.

At operation step 601, the CU-CP NF 101 transmits a NF discovery request to the SCP 215. The NF discovery request comprises an AMF parameter set for an AMF selection. The AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs.

At operation step 603, the SCP 215 selects at least one AMF 103 upon receiving the NF discovery request.

At operation step 605, the SCP 215 transmits a NF discovery response to the CU-CP NF 101 upon completing the selection for the at least one AMF 103. The NF discovery response comprises of the at least one AMF 103.

At operation step 607, the CU-CP NF 101 establishes a connection with one of the at least one AMF 103 for services.

FIG. 7 illustrates a network entity according to embodiments of the present disclosure. Referring to the FIG. 7, the network entity 700 may include a processor 710, a transceiver 720 and a memory 730. However, all of the illustrated components are not essential. The network entity 700 may be implemented by more or less components than those illustrated in FIG. 7. In addition, the processor 710 and the transceiver 720 and the memory 730 may be implemented as a single chip according to an embodiment.

The aforementioned components will now be described in detail.

The processor 710 may include one or more processors or other processing devices that control the proposed function, process, and/or method. Operation of the network entity 700 may be implemented by the processor 710.

The processor 710 may control a series of processes for the network entity to be able to operate according to the above-described embodiments. The processor 710 may include at least one processor. The methods according to the embodiments described in the specification or claims of the present disclosure may be implemented in hardware, software, or a combination of hardware and software.

The processor 710 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The transceiver 720 may include a RF transmitter for up-converting and amplifying a transmitted signal, and a RF receiver for down-converting a frequency of a received signal. However, according to another embodiment, the transceiver 720 may be implemented by more or less components than those illustrated in components.

The transceiver 720 may be connected to the processor 710 and transmit and/or receive a signal. The signal may include control information and data. In addition, the transceiver 720 may receive the signal through a wireless channel and output the signal to the processor 710. The transceiver 720 may transmit a signal output from the processor 710 through the wireless channel.

The memory 730 may store the control information or the data included in a signal obtained by the network entity 700. The memory 730 may be connected to the processor 710 and store at least one instruction or a protocol or a parameter for the proposed function, process, and/or method. The memory 730 may include read-only memory (ROM) and/or random access memory (RAM) and/or hard disk and/or CD-ROM and/or DVD and/or other storage devices.

In an embodiment, the network entity 700 may be implemented as a network entity for at least one network function of a core network. For example, the network entity may include AMF, NFR, SCP, a session management function (SMF), a policy control function (PCF), a user plane function (UPF), a network slicing selection function (NSSF), an authentication server function (AUSF), a Unified Data Management (UDM) and a network exposure function (NEF), or any combination thereof, but the network entity is not limited thereto.

According to an embodiment of the present disclosure, a CU-CP NF directly communicates with a target AMF using locally configured parameters. In an embodiment, an AMF selection is done via a NRF by the CU-CP. In an embodiment, the CU-CP NF does discovery of an AMF by querying the NRF. Based on the discovery result, the CU-CP NF does the selection of the AMF set or a specific AMF of the AMF set. Then the CU-CP NF sends the request to SCP containing the address of the selected AMF. In an embodiment, the CU-CP NF adds any necessary discovery and selection parameters required to find a suitable AMF to a request message. The SCP uses a request address and the discovery and selection parameters in the request message to route the request to a suitable AMF instance.

Some of the advantages of the present disclosure are listed below.

Access and mobility is necessary for any wireless communication. In the present disclosure, the RAN to the CN both support service-based architecture with full procedures for discovery and selection of AMF in 6G. As a result, there is no NG interface between the RAN and the CN. This (1) overcomes the drawback of a point-to-point interaction as mentioned in the background i.e., the RAN as well as the AMF becomes an anchor for all UE control messages and each message has to pass through the RAN and the AMF and (2) enables end-to-end service-based architecture, thereby, making the 6G system more efficient, flexible, and simple.

Some of the clauses are mentioned below.

[1]: A method for NF selection for access and mobility management in a service-based architecture, the method comprising:
configuring, by a CU-CP NF, the CU-CP NF locally using an AMF parameter set to enable selection of an AMF at the CU-CP NF;
transmitting, by the CU-CP NF, a service request to the AMF, wherein the service request comprises the AMF parameter set; and
receiving, by the CU-CP NF, a service response, in response to the service request, from the AMF to establish a connection with the AMF for services.

[2]: The method described in [1], prior to configuring the CU-CP NF using the AMF parameter set, the method comprising:
receiving, by the CU-CP NF, a 6G-TMSI or 6G-GUAMI from a UE.

[3]: The method described in [1], wherein the AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs.

[4]: A system for NF selection for access and mobility management in a service-based architecture, the system comprising:
a CU-CP NF comprising:
a processor; and
a memory communicatively coupled to the processor, the processor is configured to:
configure the CU-CP NF locally using an AMF parameter set to enable selection of an AMF at the CU-CP NF;
transmit a service request to the AMF, wherein the service request comprises the AMF parameter set; and
receive a service response from the AMF to establish a connection with the AMF for services.

[5]: The system described in [4], wherein the CU-CP NF is configured to: receive a 6G-TMSI or 6G-GUAMI from a UE.

[6]: The system described in [4], wherein the AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs.

[7]: A method for NF selection for access and mobility management in a service-based architecture, the method comprising:
transmitting, by a CU-CP NF, a NF discovery request to a NRF, wherein the NF discovery request comprises an AMF parameter set for an AMF selection;
selecting, by the NRF, at least one AMF upon receiving the NF discovery request;
transmitting, by the NRF, a NF discovery response to the CU-CP NF upon completing the selection for the at least one AMF, wherein the NF discovery response comprises of the at least one AMF; and
establishing, by the CU-CP NF, a connection with one of the at least one AMF for services.

[8]: The method described in [7], wherein the NF discovery request is transmitted to the NRF when a UE provides no 6G-TMSI or 6G-GUAMI to the CU-CP NF, or when the UE provides non-usable 6G-TMSI or 6G-GUAMI to the CU-CP NF, or when the UE provides 6G-GUAMI to the CU-CP NF that is unavailable.

[9]: The method described in [7], wherein the AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs.

[10]: The method described in [7], wherein selecting the at least one AMF upon receiving the NF discovery request further comprising:
searching, by the NRF, the at least one AMF upon receiving the NF discovery request using the AMF parameter set.

[11]: The method described in [10], wherein searching the at least one AMF upon receiving the NF discovery request using the AMF parameter set excludes an AMF among the at least one AMF that is non-working.

[12]: The method described in [10], wherein searching the at least one AMF upon receiving the NF discovery request using the AMF parameter set excludes an AMF among the at least one AMF that is serving a different country than where a UE is currently located.

[13]: The method described in [7], wherein establishing the connection with one of the at least one AMF for services comprising:
selecting, by the CU-CP NF, one of the at least one AMF based on one or more factors in the AMF parameter set,
wherein the one or more factors include an AMF region identity, an AMF set identity, an NSSAI, local operator policies, an IAB indication, an NB-IoT RAT type, 6G CIoT features indicated in RRC signalling by a UE, a SNPN on boarding indication as indicated in the RRC signalling by the UE, a location of the UE, an availability of AMFs, and weight factor across the AMFs.

[14]: The method described in [7], wherein establishing the connection with one of the at least one AMF for services comprising:
transmitting, by the CU-CP NF, a service request to a SCP to establish the connection for services with the selected AMF; and
receiving, by the CU-CP NF, a service response from the SCP confirming connection for services with the selected AMF in response to the service request, wherein the service request comprises the AMF parameter set of the selected AMF.

[15]: The method described in [7], wherein prior to transmitting the NF discovery request to the NRF, the method comprising:
receiving, by the NRF, associated AMF details from the at least one AMF; and
storing, by the NRF, the AMF details associated with the at least one AMF,
wherein the AMF details comprise AMF names, a list of 6G-GUAMIs, an availability of AMFs, and weight factor across the AMFs.

[16]: The method described in [15], further comprising:
receiving, by the NRF, a failure notification from one of the at least one AMF,
wherein the failure notification indicates non-working of an AMF among the at least one AMF.

[17]: A system for NF selection for access and mobility management in a service-based architecture, the system comprising:
a CU-CP NF comprising:
a first processor; and
a first memory communicatively coupled to the first processor, the first processor is configured to:
transmit a NF discovery request to a NRF, wherein the NF discovery request comprises an AMF parameter set for an AMF selection; and
establish a connection with one of the at least one AMF for services;
the NRF comprising:
a second processor; and
a second memory communicatively coupled to the second processor, the second processor is configured to:
select at least one AMF upon receiving the NF discovery request; and
transmit a NF discovery response to the CU-CP NF upon completing the selection for the at least one AMF, wherein the NF discovery response comprises of the at least one AMF.

[18]: The system described in [17], wherein the NF discovery request is transmitted to the NRF when a UE provides no 6G-TMSI or 6G-GUAMI to the CU-CP NF, or when the UE provides non-usable 6G-TMSI or 6G-GUAMI to the CU-CP NF, or when the UE provides 6G-GUAMI to the CU-CP NF that is unavailable.

[19]: The system described in [17], wherein the AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs.

[20]: The system described in [17], wherein the NRF is configured to:
search the at least one AMF upon receiving the NF discovery request using the AMF parameter set.

[21]: The system described in [20], wherein searching the at least one AMF upon receiving the NF discovery request using the AMF parameter set excludes an AMF among the at least one AMF that is non-working.

[22]: The system described in [20], wherein searching the at least one AMF upon receiving the NF discovery request using the AMF parameter set excludes an AMF among the at least one AMF that is serving a different country than where a UE is currently located.

[23]: The system described in [17], wherein the CU-CP NF is configured to:
select one of the at least one AMF based on one or more factors in the AMF parameter set,
wherein the one or more factors include an AMF region identity, an AMF set identity, an NSSAI, local operator policies, an IAB indication, an NB-IoT RAT type, 6G CIoT features indicated in RRC signalling by a UE, a SNPN on boarding indication as indicated in the RRC signalling by the UE, a location of the UE, an availability of AMFs, and weight factor across the AMFs.

[24]: The system described in [17], wherein the CU-CP NF is configured to:
transmit a service request to a SCP to establish the connection for services with the selected AMF; and
receive a service response from the SCP confirming connection for services with the selected AMF in response to the service request,
wherein the service request comprises the AMF parameter set of the selected AMF.

[25]: The system described in [17], wherein prior to transmitting the NF discovery request to the NRF, the NRF is configured to:
receive associated AMF details from the at least one AMF; and
store the AMF details associated with the at least one AMF,
wherein the AMF details comprise AMF names, a list of 6G-GUAMIs, an availability of AMFs, and weight factor across the AMFs.

[26]: The system described in [25], wherein the NRF is configured to:
receive a failure notification from one of the at least one AMF,
wherein the failure notification indicates non-working of an AMF among the at least one AMF.

[27]: A method for NF selection for access and mobility management in a service-based architecture, the method comprising:
transmitting, by a CU-CP NF, a NF discovery request to a SCP, wherein the NF discovery request comprises an AMF parameter set for an AMF selection;
selecting, by the SCP, at least one AMF upon receiving the NF discovery request;
transmitting, by the SCP, a NF discovery response to the CU-CP NF upon completing the selection for the at least one AMF, wherein the NF discovery response comprises of the at least one AMF; and
establishing, by the CU-CP NF, a connection with one of the at least one AMF for services.

[28]: The method described in [27], wherein the NF discovery request is transmitted to the SCP when a UE provides no 6G-TMSI or 6G-GUAMI to the CU-CP NF.

[29]: The method described in [27], wherein the AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs.

[30]: The method described in [27], wherein the selecting the at least one AMF upon receiving the NF discovery request further comprising:
searching, by the SCP, the at least one AMF upon receiving the NF discovery request using the AMF parameter set.

[31]: The method described in [27], wherein establishing the connection with one of the at least one AMF for services comprising:
selecting, by the CU-CP NF, one of the at least one AMF based on one or more factors in the AMF parameter set,
wherein the one or more factors include an AMF region identity, an AMF set identity, an NSSAI, local operator policies, an IAB indication, an NB-IoT RAT type, 6G CIoT features indicated in RRC signalling by a UE, a SNPN on boarding indication as indicated in the RRC signalling by the UE, a location of the UE, an availability of AMFs, and weight factor across the AMFs.

[32]: A system for NF selection for access and mobility management in a service-based architecture, the system comprising:
a CU-CP NF comprising:
a first processor; and
a first memory communicatively coupled to the first processor, the first processor is configured to:
transmit a NF discovery request to a SCP, wherein the NF discovery request comprises an AMF parameter set for an AMF selection; and
establish a connection with one of the at least one AMF for services;
the SCP comprising:
a third processor; and
a third memory communicatively coupled to the third processor, the third processor is configured to:
select at least one AMF upon receiving the NF discovery request; and
transmit a NF discovery response to the CU-CP NF upon completing the selection for the at least one AMF, wherein the NF discovery response comprises of the at least one AMF.

[33]: The system described in [32], wherein the NF discovery request is transmitted to the SCP when a UE provides no 6G-TMSI or 6G-GUAMI to the CU-CP NF.

[34]: The system described in [32], wherein the AMF parameter set comprises at least one of an AMF region identity, an AMF set identity, NSSAI, local operator policies, IAB indication, NB-IoT RAT type, 6G CIoT features indicated in RRC signalling by a UE, a Category M indication, a SNPN onboarding indication as indicated in the RRC signalling by the UE, a location of the UE, an availability of AMFs, and weight factor across the AMFs.

[35]: The system described in [32], wherein the SCP is configured to: search the at least one AMF upon receiving the NF discovery request using the AMF parameter set.

[36]: The system described in [32], wherein the CU-CP NF configured to:
select one of the at least one AMF based on one or more factors in the AMF parameter set,
wherein the one or more factors include an AMF region identity, an AMF set identity, an NSSAI, local operator policies, an IAB indication, an NB-IoT RAT type, 6G CIoT features indicated in RRC signalling by a UE, a SNPN on boarding indication as indicated in the RRC signalling by the UE, a location of the UE, an availability of AMFs, and weight factor across the AMFs.

In an embodiment, a method for Network Function (NF) selection for access and mobility management in a service-based architecture may comprise: receiving, by a Network Repository Function (NRF), from a Central Unit (CU)-Control Plane (CP) NF, a NF discovery request, wherein the NF discovery request comprises an Access and Mobility Management Function (AMF) parameter set for an AMF selection; selecting, by the NRF, at least one AMF upon receiving the NF discovery request; and transmitting, by the NRF, a NF discovery response to the CU-CP NF upon completing the selection for the at least one AMF, wherein the NF discovery response comprises of the at least one AMF.

In an embodiment, a method for Network Function (NF) selection for access and mobility management in a service-based architecture may comprise: receiving, by a Service Communication Proxy (SCP), from a Central Unit (CU)-Control Plane (CP) NF, a NF discovery request, wherein the NF discovery request comprises an Access and Mobility Management Function (AMF) parameter set for an AMF selection; selecting, by the SCP, at least one AMF upon receiving the NF discovery request; and transmitting, by the SCP, a NF discovery response to the CU-CP NF upon completing the selection for the at least one AMF, wherein the NF discovery response comprises of the at least one AMF.

With respect to the use of substantially any plural and singular terms herein, those having skill in the art can translate from the plural to the singular and from the singular to the plural as is appropriate to the context or application. The various singular or plural permutations may be expressly set forth herein for sake of clarity. One or more computer-readable storage media may be utilized in implementing embodiments consistent with the present disclosure. A computer-readable storage medium refers to any type of physical memory on which a software (program) readable by an information processing apparatus may be stored. The information processing apparatus includes a processor and a memory, and the processor executes a process of the software. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include RAM, ROM, volatile memory, non-volatile memory, hard drives, CD ROMs, DVDs, flash drives, disks, and any other known physical storage media.

The described operations may be implemented as a method, a system, or an article of manufacture using at least one of standard programming and engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, PGA, ASIC, etc.).

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The terms “AMF details”, and “AMF information” are used interchangeably and means the same.

The terms “AMF pool”, and “AMF set” are used interchangeably and means the same.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device or article (whether or not they cooperate) may be used in place of a single device or article. Similarly, where more than one device or article is described herein (whether or not they cooperate), it will be readily apparent that a single device or article may be used in place of the more than one device, or article, or a different number of devices or articles may be used instead of the shown number of devices or programs. At least one of the functionalities and the features of a device may be alternatively embodied by one or more other devices which are not explicitly described as having such functionality or features. Thus, other embodiments of the invention need not include the device itself.

The illustrated operations of FIGS. 4, 5, and 6 show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

TABLE 2
REFERRAL NUMERALS:

| Reference number | Description |
|---|---|
| 101 | CU-CP NF |
| 103 | AMFs |
| 1031 | AMF 1 |
| 1032 | AMF 2 |
| 201 | NRF |
| 215 | SCP |

1. A method for Network Function (NF) selection for access and mobility management in a service-based architecture, the method comprising:
configuring, by a Central Unit (CU)-Control Plane (CP) NF, the CU-CP NF locally using an Access and Mobility Management Function (AMF) parameter set to enable selection of an AMF at the CU-CP NF;
transmitting, by the CU-CP NF, a service request to the AMF, wherein the service request comprises the AMF parameter set; and
receiving, by the CU-CP NF, a service response from the AMF to establish a connection with the AMF for services.

2. The method as claimed in claim 1, prior to configuring the CU-CP NF using the AMF parameter set, the method comprising:
receiving, by the CU-CP NF, a Sixth Generation (6G) Temporary Mobile Subscriber Identity (6G-TMSI) or a 6G Globally Unique AMF ID (6G-GUAMI) from a user equipment (UE).

3. The method as claimed in claim 1, wherein the AMF parameter set comprises at least one of an AMF region identity, an AMF set identity, Network Slice Selection Assistance Information (NSSAI), local operator policies, an Integrated Access and Backhaul (IAB) indication, a Narrowband Internet of Things (NB-IoT) Radio Access Technology (RAT) type, 6G Cellular IoT (CIoT) features indicated in Radio Resource Control (RRC) signalling by a user equipment (UE), a Category M indication, a Standalone Non-Public Network (SNPN) onboarding indication as indicated in the RRC signalling by the UE, a location of the UE, an availability of AMFs, and a weight factor across the AMFs.

4. A method for Network Function (NF) selection for access and mobility management in a service-based architecture, the method comprising:
transmitting, by a Central Unit (CU)-Control Plane (CP) NF, a NF discovery request to a Network Repository Function (NRF), wherein the NF discovery request comprises an Access and Mobility Management Function (AMF) parameter set for an AMF selection;
receiving, by the CU-UP NF, from the NRF, a NF discovery response in response to the NF discovery request, wherein the NF discovery response comprises of the at least one AMF; and
establishing, by the CU-CP NF, a connection with one of the at least one AMF for services.

5. The method as claimed in claim 4, wherein the NF discovery request is transmitted to the NRF in case that the CU-CP NF receives no Sixth Generation (6G) Temporary Mobile Subscriber Identity (6G-TMSI) or 6G Globally Unique AMF ID (6G-GUAMI) from a user equipment (UE), or in case that the CU-CP NF receives non-usable 6G-TMSI or 6G-GUAMI from the UE, or in case that the CU-CP NF receives a 6G-GUAMI that is unavailable from the UE.

6. The method as claimed in claim 4, wherein the AMF parameter set comprises at least one of an AMF region identity, an AMF set identity, Network Slice Selection Assistance Information (NSSAI), local operator policies, an Integrated Access and Backhaul (IAB) indication, a Narrowband Internet of Things (NB-IoT) Radio Access Technology (RAT) type, 6G Cellular IoT (CIoT) features indicated in Radio Resource Control (RRC) signalling by a user equipment (UE), a Category M indication, a Standalone Non-Public Network (SNPN) onboarding indication as indicated in the RRC signalling by the UE, a location of the UE, an availability of AMFs, and a weight factor across the AMFs.

7. The method as claimed in claim 4, wherein establishing the connection with one of the at least one AMF for services comprising:
selecting, by the CU-CP NF, one of the at least one AMF based on one or more factors in the AMF parameter set,
wherein the one or more factors include an AMF region identity, an AMF set identity, Network Slice Selection Assistance Information (NSSAI), local operator policies, an Integrated Access and Backhaul (IAB) indication, a Narrowband Internet of Things (NB-IoT) Radio Access Technology (RAT) type, 6G Cellular IoT (CIoT) features indicated in RRC signalling by a user equipment (UE), a Standalone Non-Public Network (SNPN) on boarding indication as indicated in the RRC signalling by the UE, a location of the UE, an availability of AMFs, and weight factor across the AMFs.

8. The method as claimed in claim 4, wherein establishing the connection with one of the at least one AMF for services comprising:
transmitting, by the CU-CP NF, a service request to a Service Communication Proxy (SCP) to establish the connection for services with the one of the at least one AMF; and
receiving, by the CU-CP NF, a service response from the SCP confirming connection for services with the one of the at least one AMF in response to the service request,
wherein the service request comprises the AMF parameter set of the one of the at least one AMF.

9. A method for Network Function (NF) selection for access and mobility management in a service-based architecture, the method comprising:
receiving, by a Network Repository Function (NRF), from a Central Unit (CU)-Control Plane (CP) NF, a NF discovery request, wherein the NF discovery request comprises an Access and Mobility Management Function (AMF) parameter set for an AMF selection;
selecting, by the NRF, at least one AMF upon receiving the NF discovery request; and
transmitting, by the NRF, a NF discovery response to the CU-CP NF upon completing the selection for the at least one AMF, wherein the NF discovery response comprises of the at least one AMF.

10. The method as claimed in claim 9, wherein prior to receiving the NF discovery request from the CU-CP NF, the method comprising:
receiving, by the NRF, associated AMF details from the at least one AMF; and
storing, by the NRF, the AMF details associated with the at least one AMF,
wherein the AMF details comprise AMF names, a list of 6G-GUAMIs, an availability of AMFs, and weight factor across the AMFs.

11. A method for Network Function (NF) selection for access and mobility management in a service-based architecture, the method comprising:
transmitting, by a Central Unit (CU)-Control Plane (CP) NF, a NF discovery request to a Service Communication Proxy (SCP), wherein the NF discovery request comprises an Access and Mobility Management Function (AMF) parameter set for an AMF selection;
receiving, by the CU-CP NF, from the SCP, a NF discovery response in response to the NF discovery request, wherein the NF discovery response comprises of the at least one AMF; and
establishing, by the CU-CP NF, a connection with one of the at least one AMF for services.

12. The method as claimed in claim 10, wherein the NF discovery request is transmitted to the SCP in case that the CU-CP NF receives no Sixth Generation (6G) Temporary Mobile Subscriber Identity (6G-TMSI) or 6G Globally Unique AMF ID (6G-GUAMI) from a user equipment (UE).

13. The method as claimed in claim 10, wherein the AMF parameter set comprises at least one of an AMF region identity, an AMF set identity, Network Slice Selection Assistance Information (NSSAI), local operator policies, an Integrated Access and Backhaul (IAB) indication, a Narrowband Internet of Things (NB-IoT) Radio Access Technology (RAT) type, 6G Cellular IoT (CIoT) features indicated in Radio Resource Control (RRC) signalling by a user equipment (UE), a Category M indication, a Standalone Non-Public Network (SNPN) onboarding indication as indicated in the RRC signalling by the UE, a location of the UE, an availability of AMFs, and weight factor across the AMFs.

14. The method as claimed in claim 10, wherein establishing the connection with one of the at least one AMF for services comprising:
selecting, by the CU-CP NF, one of the at least one AMF based on one or more factors in the AMF parameter set,
wherein the one or more factors include an AMF region identity, an AMF set identity, Network Slice Selection Assistance Information (NSSAI), local operator policies, an Integrated Access and Backhaul (IAB) indication, an Narrowband Internet of Things (NB-IoT) Radio Access Technology (RAT) type, 6G Cellular IoT (CIoT) features indicated in Radio Resource Control (RRC) signalling by a user equipment (UE), a Standalone Non-Public Network (SNPN) on boarding indication as indicated in the RRC signalling by the UE, a location of the UE, an availability of AMFs, and weight factor across the AMFs.

15. A method for Network Function (NF) selection for access and mobility management in a service-based architecture, the method comprising:
receiving, by a Service Communication Proxy (SCP), from a Central Unit (CU)-Control Plane (CP) NF, a NF discovery request, wherein the NF discovery request comprises an Access and Mobility Management Function (AMF) parameter set for an AMF selection;
selecting, by the SCP, at least one AMF upon receiving the NF discovery request; and
transmitting, by the SCP, a NF discovery response to the CU-CP NF upon completing the selection for the at least one AMF, wherein the NF discovery response comprises of the at least one AMF.
